(19) United States
(12) Patent Application Publication
(10) Pub. No.: US 2018/0315391 A1
(43) Pub. Date: Nov. 1, 2018

(54) LIQUID CRYSTAL DISPLAY AND GAMMA CURVE CORRECTION METHOD THEREOF

(71) Applicant: RICHTEK TECHNOLOGY CORPORATION, Zhubei City (TW)

(72) Inventors: Der-Jiunn WANG, Zhubei City (TW); Chung-Hsien TSO, Zhubei City (TW); Chun-I LIN, Yangmei City (TW); Hsing-Shen HUANG, Zhubei City (TW)

(21) Appl. No.: 16/027,543

(22) Filed: Jul. 5, 2018

Related U.S. Application Data
(63) Continuation-in-part of application No. 14/954,513, filed on Nov. 30, 2015, now Pat. No. 10,043,471.
(60) Provisional application No. 62/090,461, filed on Dec. 11, 2014.

(30) Foreign Application Priority Data
Apr. 11, 2018 (TW) 107112407

(51) Int. Cl. G09G 3/36; G02F 1/133

(52) U.S. Cl. CPC G09G 3/3696; G09G 3/3607; G09G 2300/0819; G09G 2320/0673; G09G 2320/0276; G02F 1/13306

(57) ABSTRACT

A Gamma curve correction method for an LCD sets a ground potential of the LCD as a common voltage and adjusts at least one of a plurality of positive Gamma voltages and a plurality of negative Gamma voltages of the LCD such that the central voltage value of a Gamma curve established by the positive Gamma voltages and the negative Gamma voltages becomes closer to the common voltage. As a result, flickers existing in the images of the LCD are improved.

### CROSS REFERENCE TO RELATED APPLICATIONS

This application is a Continuation-in-Part of U.S. patent application Ser. No. 14/954,513, filed 30 Nov. 2015, which claims the benefit of U.S. provisional patent application Ser. No. 62/090,461, filed 11 Dec. 2014. This application further claims the priority benefit of Taiwan patent Application No. 107112407, filed 11 Apr. 2018. The disclosure of each of the forgoing applications is incorporated herein by reference.

### FIELD OF THE INVENTION

The present invention is related generally to a method for improving the flicker existing in a liquid crystal display (LCD) and, more particularly, to a Gamma curve correction method for an LCD.

### BACKGROUND OF THE INVENTION

In an LCD, a Gamma curve and a common voltage Vcom influence the smooth level of the color and the image of the LCD. Since the liquid crystal molecules of the LCD cannot be fixed at a certain voltage for too long, Gamma voltages, which are used to drive the liquid crystal molecules, are divided into those with a positive polarity and those with a negative polarity. When the common voltage Vcom is at the center of the positive Gamma voltages and the negative Gamma voltages, i.e. when the common voltage Vcom equals the central voltage value of the Gamma curve, the positive and negative Gamma voltages having the same voltage difference from the common voltage Vcom produce the same grayscale level. In a conventional LCD, the Gamma voltages have preset fixed values that cannot be changed, so it is required to adjust the common voltage Vcom to the central voltage value of the Gamma curve.

FIG. 8 shows a conventional LCD 20 that includes a Gamma voltage circuit 22, a source driver 24, a common voltage control circuit 26, a display panel 28, and a common electrode 30 for the display panel. The Gamma voltage circuit 22 is configured to provide a plurality of positive Gamma voltages PV0-PV1023 and a plurality of negative Gamma voltages NV0-NV1023. The source driver 24 selects from the plurality of positive Gamma voltages PV0-PV1023 and the plurality of negative Gamma voltages NV0-NV1023 the Gamma voltages required to drive the display panel 28. The common voltage control circuit 26 provides a common voltage Vcom to the common electrode 30. The voltage differences between the Gamma voltages provided by the source driver 24 and the common voltage Vcom at the common electrode 30 determine the grayscale levels of the pixels in the display panel.

FIG. 1 shows a Gamma curve 10 and a common voltage Vcom, in which the Gamma curve 10 is established by a plurality of positive Gamma voltages PV0-PV1023 and a plurality of negative Gamma voltages NV0-NV1023. The plurality of positive Gamma voltages PV0-PV1023 and the plurality of negative Gamma voltages NV0-NV1023 control the grayscale levels D0-D1023 of an LCD. FIG. 2 shows the common voltage control circuit 26 in FIG. 8. The common voltage control circuit 26 controls the common voltage Vcom and includes an operation amplifier 16 for generating and controlling the common voltage Vcom. As shown by the waveform 12 in FIG. 1, when the common voltage Vcom is not at the central voltage value 14 of the Gamma curve 10, flickers exist in the image of the LCD. At this time, the common voltage Vcom can be adjusted equal to the central voltage value 14 of the Gamma curve 10 by adjusting a setting signal Vset that is provided to the operation amplifier 16 so as to improve the flicker issue of the image. However, such a conventional method for adjusting the common voltage Vcom needs the extra operation amplifier 16. Moreover, the operation amplifier 16 needs a driving current, which causes extra power loss. In addition, due to the bandwidth limitation of the operation amplifier 16, the operation amplifier 16 cannot correct the common voltage Vcom immediately when the common voltage Vcom varies quickly. Further, as shown by the waveform 18 in FIG. 2, the common voltage Vcom provided by the operation amplifier 16 is not fixed but oscillatory, and this will cause the flickers of the grayscale levels, resulting in poorer display performance.

### SUMMARY OF THE INVENTION

An objective of the present invention is to provide an LCD and a

Gamma curve correction method for the LCD.

Another objective of the present invention is to provide an LCD and a method that can correct a zero-flicker value such that the zero-flicker value coincides with a common voltage by Gamma voltage correction.

According to the present invention, a Gamma curve correction method for an LCD includes the steps of setting a ground potential of the LCD as a common voltage and adjusting at least one of a plurality of positive Gamma voltages and a plurality of negative Gamma voltages used to control the grayscale levels of the LCD such that the central voltage value of a Gamma curve established by the positive Gamma voltages and the negative Gamma voltages becomes closer to the common voltage.

According to the present invention, an LCD includes a display panel, a Gamma voltage correction circuit, and a source driver. The display panel has a panel common electrode. The panel common electrode is connected to a ground terminal, and the voltage at the panel common electrode serves as a common voltage for the display panel. The Gamma voltage correction circuit provides a plurality of pairs of Gamma voltages for controlling the grayscale levels of the display panel and corrects the plurality of pairs of Gamma voltages according to a correction signal in order to make the zero-flicker value of each pair of Gamma voltages equal the common voltage. Each pair of Gamma voltages include a positive Gamma voltage and a negative Gamma voltage that correspond to the same grayscale level, and the zero-flicker value is a voltage value that enables the paired positive and negative Gamma voltages to produce the same brightness. The source driver receives the plurality of pairs of Gamma voltages from the Gamma voltage correction circuit and provides the required Gamma voltages to the display panel.

According to the present invention, a Gamma curve correction method for an LCD is carried out by setting the ground potential of the LCD as a common voltage and adjusting a plurality of pairs of Gamma voltages according to a correction signal such that the zero-flicker value of each pair of Gamma voltages equals the common voltage. Each pair of Gamma voltages include a positive Gamma voltage and a negative Gamma voltage that correspond to the same grayscale level, and the zero-flicker value of each pair of Gamma voltages is a voltage value that enables the paired positive and negative Gamma voltages to produce the same brightness.

The Gamma curve correction method according to the present invention does not need an operation amplifier to adjust the common voltage. Accordingly, the costs and the power loss can be reduced. Moreover, as the ground potential of an LCD employing the Gamma curve correction method is a fixed value, the common voltage will not oscillate, and the grayscale levels will not flicker. As a result, a better display performance can be obtained.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 shows a Gamma curve and a common voltage Vcom;

FIG. 2 shows a circuit for controlling the common voltage Vcom;

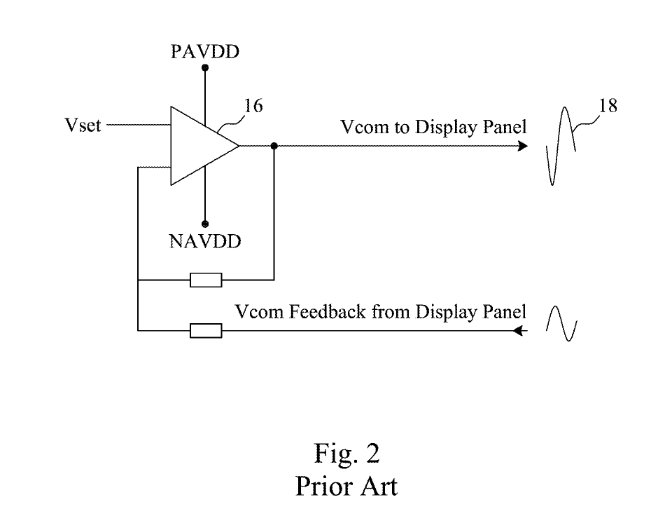

FIG. 3 is a flowchart of a Gamma curve correction method according to the present invention;

FIG. 4 is a circuit diagram to which the Gamma curve correction method of the present invention is applied;

FIG. 5 is a first embodiment of the step S22 shown in FIG. 3;

FIG. 6 is a second embodiment of the step S22 shown in FIG. 3;

FIG. 7 is a third embodiment of the step S22 shown in FIG. 3;

FIG. 8 shows a conventional LCD;

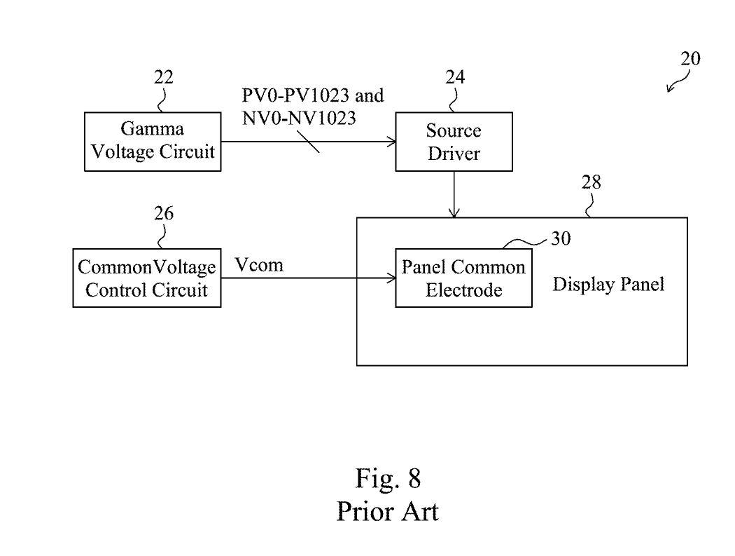

FIG. 9 shows a Gamma curve whose central voltage value equals a common voltage Vcom;

FIG. 10 shows an LCD according to the present invention;

FIG. 11 shows a first embodiment of the Gamma voltage correction circuit in FIG. 10;

FIG. 12 shows a second embodiment of the Gamma voltage correction circuit in FIG. 10; and

FIG. 13 shows a different layout of the circuit in FIG. 12.

### DETAILED DESCRIPTION OF THE INVENTION

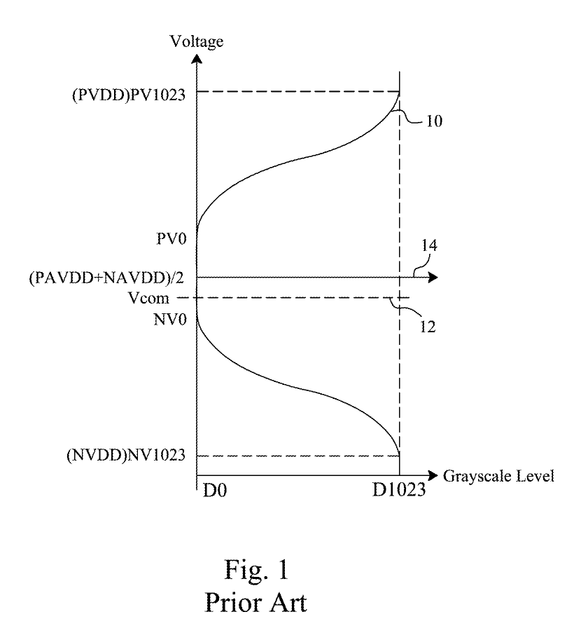

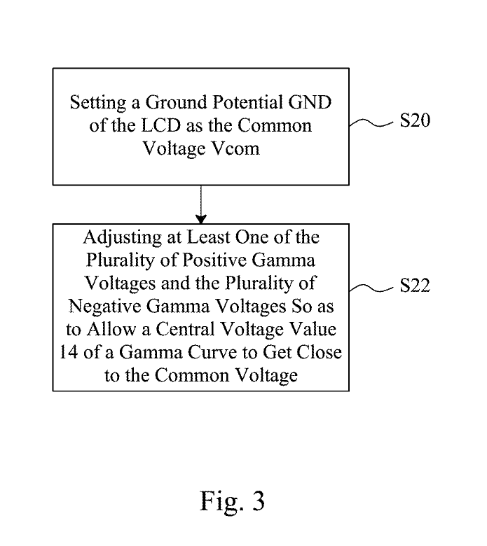

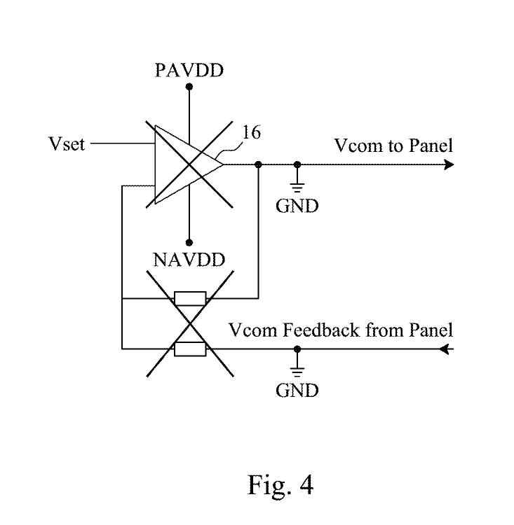

Referring to FIG. 3, a flowchart of a Gamma curve correction method of the present invention is shown. Referring to FIG. 1 and FIG. 3, the Gamma curve correction method of the present invention sets a ground potential GND of an LCD as a common voltage Vcom (the step S20). Then, at least one of a plurality of positive Gamma voltages PV0-PV1023 and a plurality of negative Gamma voltages NV0-NV1023 is adjusted such that the central voltage value 14 of a Gamma curve 10 becomes closer to the common voltage Vcom (the step S22). Thus, the flicker issue of images displayed by the LCD can be improved. Preferably, the adjusted central voltage value 14 of the Gamma curve 10 equals the common voltage Vcom. FIG. 4 shows a circuit diagram to which the Gamma curve correction method of the present invention is applied, in which the conventional operation amplifier 16 is removed, so that fewer costs and less power loss will be achieved. Moreover, the ground potential GND of the LCD is a fixed value, and therefore the common voltage Vcom does not oscillate to cause the flickers of the grayscale levels. Accordingly, a better display performance is achieved.

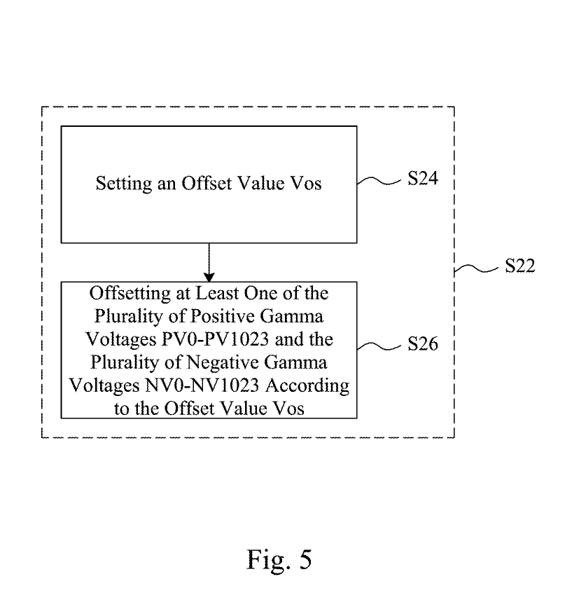

FIG. 5 shows a first embodiment of the step 22 in FIG. 3, in which the step S24 includes setting an offset value Vos, and the step S26 includes offsetting at least one of the plurality of positive Gamma voltages PV0-PV1023 and the plurality of negative Gamma voltages NV0-NV1023 according to the offset value Vos so as to adjust the central voltage value 14 of the Gamma curve 10. For example, a maximum positive Gamma voltage PV1023 or a minimum negative Gamma voltage NV1023 can be offset for adjusting the central voltage value 14 of the Gamma curve 10. Alternatively, all of the positive Gamma voltages PV0-PV1023 and the negative Gamma voltages NV0-NV1023 can be offset in order to offset the central voltage value 14 of the Gamma curve 10. There are known techniques that can utilize particular circuits and methods to calculate the difference value between a Gamma voltage and the common voltage Vcom, and a proper offset value Vos can be set according to the difference value.

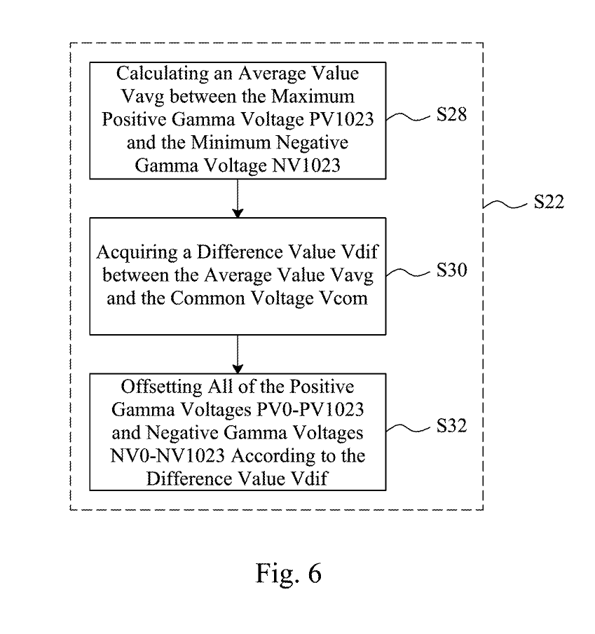

FIG. 6 shows a second embodiment of the step S22 in FIG. 3, in which a step S28 includes calculating an average value Vavg between the maximum positive Gamma voltage PV1023 and the minimum negative Gamma voltage NV1023. Then, in the step S30, the difference value Vdif between the average value Vavg and the common voltage Vcom is acquired. Finally, in the step S32, all of the positive Gamma voltages PV0-PV1023 and the negative Gamma voltages NV0-NV1023 are offset according to the difference value Vdif such that the central voltage value 14 of the Gamma curve 10 is offset. In other embodiments, the offsetting may be applied to only a part of the positive Gamma voltages PV0-PV1023 and negative Gamma voltages NV0-NV1023.

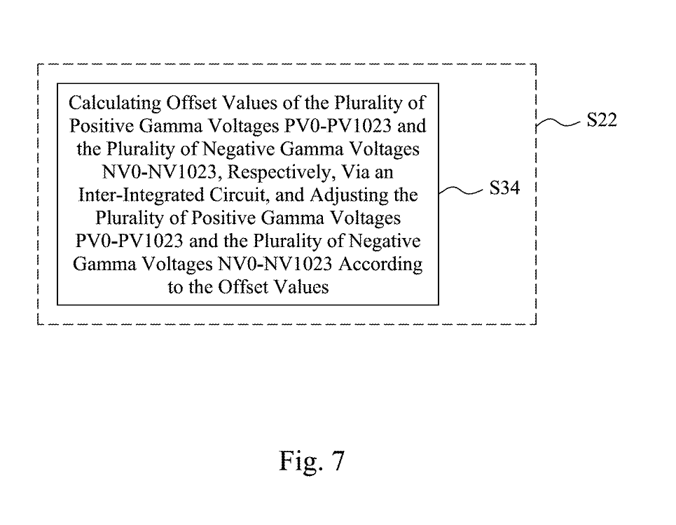

FIG. 7 shows a preferred embodiment of the step S22 in FIG. 3, in which a step S34 includes utilizing an inter-integrated circuit to calculate the offset values of the positive Gamma voltages PV0-PV1023 and of the negative Gamma voltages NV0-NV1023 respectively, and adjusting the positive Gamma voltages PV0-PV1023 and the negative Gamma voltages NV0-NV1023 according to the offset values. There are known techniques that utilize the built-in inter-integrated circuit to calculate the difference value between each Gamma voltage and the common voltage. Namely, a proper offset value can be set according to each Gamma voltage. In other embodiments, the offsetting may be applied to only a part of the positive Gamma voltages PV0-PV1023 and negative Gamma voltages NV0-NV1023.

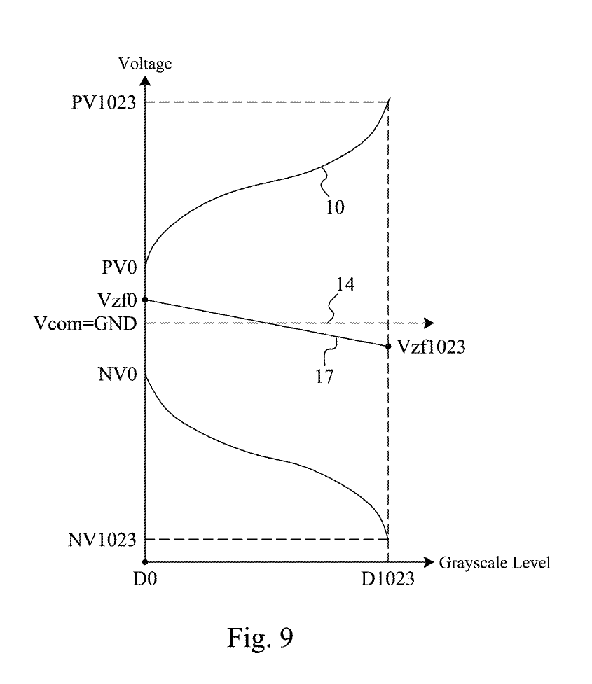

FIG. 9 shows a Gamma curve 10. Ideally, when the average voltage value of each pair of Gamma voltages (e.g. (PV0+NV0)/2 for PV0 and NV0, (PV1+NV2)/2 for PV1 and NV1, . . . , or (PV1023+NV1023)/2 for PV1023 and NV1023) equals the common voltage Vcom, each pair of positive and negative Gamma voltages that correspond to the same grayscale level (e.g. the positive Gamma voltage PV0 and the negative Gamma voltage NV0 which correspond to the grayscale level D0) will produce the same brightness. This value of producing the same brightness is referred to as a “zero-flicker value”. In practice, however, the zero-flicker value is affected by the feed-through effect of thin-film transistors (TFTs) which is different panel from panel, such that the actual curve will deviate from the common voltage Vcom. FIG. 9 shows an example of the actual zero-flicker value curve 17, in which the zero-flicker value Vzf0 of the pair of Gamma voltages PV0 and NV0 corresponding to the grayscale level D0 is higher than the central voltage value 14 and the zero-flicker value Vzf1023 of the pair of Gamma voltages PV1023 and NV1023 corresponding to the grayscale level D1023 is lower than the central voltage value 14. One goal of the present invention is to correct the zero-flicker value curve 17 such that the zero-flicker value curve 17 coincides with the common voltage Vcom by Gamma voltage correction.

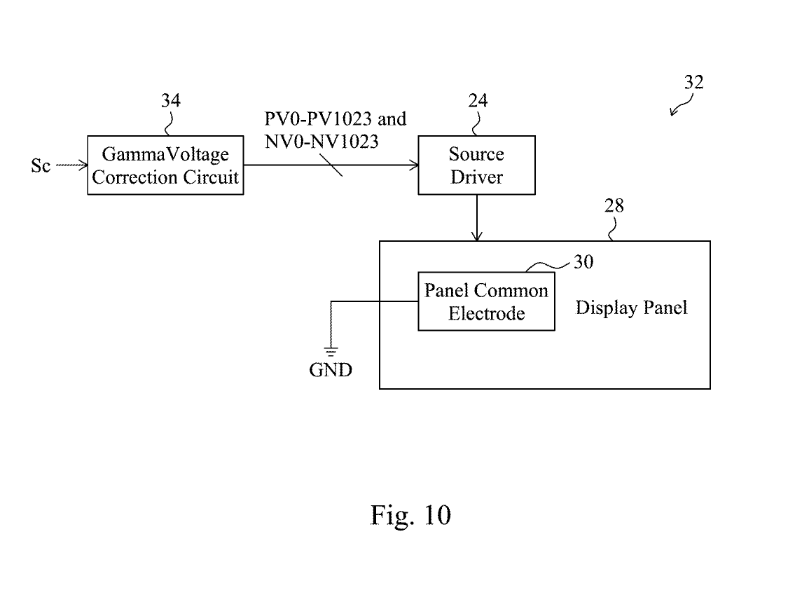

FIG. 10 shows an LCD 32 according to the present invention. The LCD 32 includes a display panel 28, a Gamma voltage correction circuit 34, and a source driver 24. The display panel 28 has a panel common electrode 30, and the panel common electrode 30 is connected to a ground terminal such that the voltage at the panel common electrode 30 is fixed at the ground potential GND; in other words, the display panel 28 has the ground potential GND as its common voltage Vcom. The Gamma voltage correction circuit 34 provides a plurality of positive Gamma voltages PV0-PV1023 and a plurality of negative Gamma voltages NV0-NV1023 for controlling the grayscale levels of the LCD. Each grayscale level D0-D1023 corresponds to a pair of Gamma voltages (e.g. PV0 and NV0, PV1 and NV1, . . . , or PV1023 and NV1023). The Gamma voltage correction circuit 34 can correct the plurality of pairs of Gamma voltages PV0 and NV0, PV1 and NV1, . . . , and PV1023 and NV1023 according to a correction signal Sc such that the zero-flicker value Vzf0-Vzf1023 of each pair of Gamma voltages equals the common voltage Vcom. The correction signal Sc may be provided externally of the LCD 32 or be generated by a circuit in the LCD 32 through real-time calculation. The source driver 24 receives the plurality of positive Gamma voltages PV0-PV1023 and the plurality of negative Gamma voltage NV0-NV1023 and then provides the required positive Gamma voltages or negative Gamma voltages to the display panel 28 to determine the grayscale level of each pixel. In contrast to the conventional LCDs, whose Gamma voltages cannot be adjusted after the LCDs are manufactured, the LCD 32 according to the present invention can correct the Gamma voltages through the correction signal Sc so that, even if environmental or other factors cause variation of the zero-flicker values Vzf0-Vzf1023, and hence flicker, after the LCD 32 is manufactured, the LCD 32 can correct the zero-flicker values Vzf0-Vzf1023 through the externally provided or internally generated correction signal Sc to improve the flicker issue.

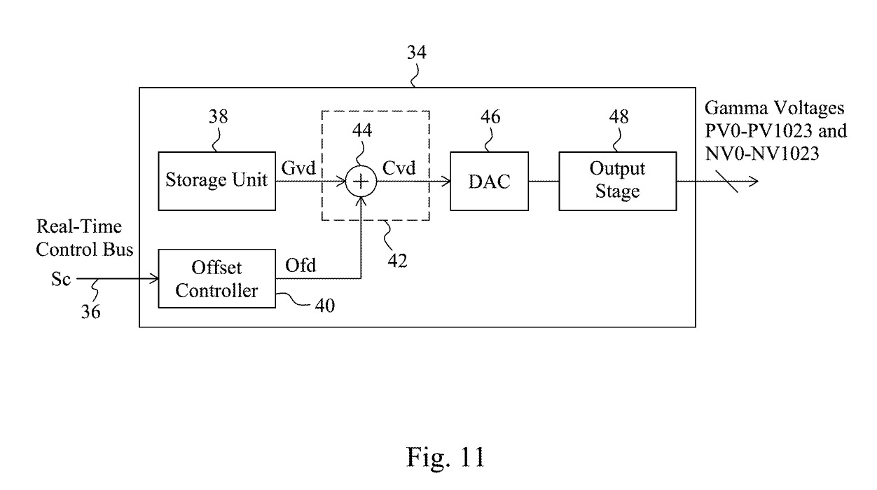

FIG. 11 shows a first embodiment of the Gamma voltage correction circuit 34 in FIG. 10. The Gamma voltage correction circuit 34 in FIG. 11 includes a storage unit 38, an offset controller 40, a correction unit 42, a digital-to-analog converter (DAC) 46, and an output stage 48. The storage unit 38 is configured to store and output a plurality of voltage data Gvd. The offset controller 40 receives the correction signal Sc in real time (either externally of the LCD 32 or from a circuit in the LCD 32) through a real-time control bus 36 and determines a plurality of offset data Ofd according to the correction signal Sc. The correction unit 42 receives the plurality of voltage data Gvd from the storage unit 38 and the plurality of offset data Ofd from the offset controller 40 and corrects the plurality of voltage data Gvd according to the plurality of offset data Ofd to generate a plurality of corrected voltage data Cvd. The correction unit 42 may be composed of an adder 44, wherein the adder 44 adds the corresponding voltage data Gvd and offset data Ofd to produce the corrected voltage data Cvd. The DAC 46 converts the plurality of corrected voltage data Cvd into a plurality of analog positive Gamma voltages PV0-PV1023 and a plurality of analog negative Gamma voltages NV0-NV1023. The output stage 48 stores the plurality of positive Gamma voltages PV0-PV1023 and the plurality of negative Gamma voltages NV0-NV1023 output from the DAC 46 and outputs the plurality of positive Gamma voltages PV0-PV1023 and the plurality of negative Gamma voltages NV0-NV1023 to the source driver 24.

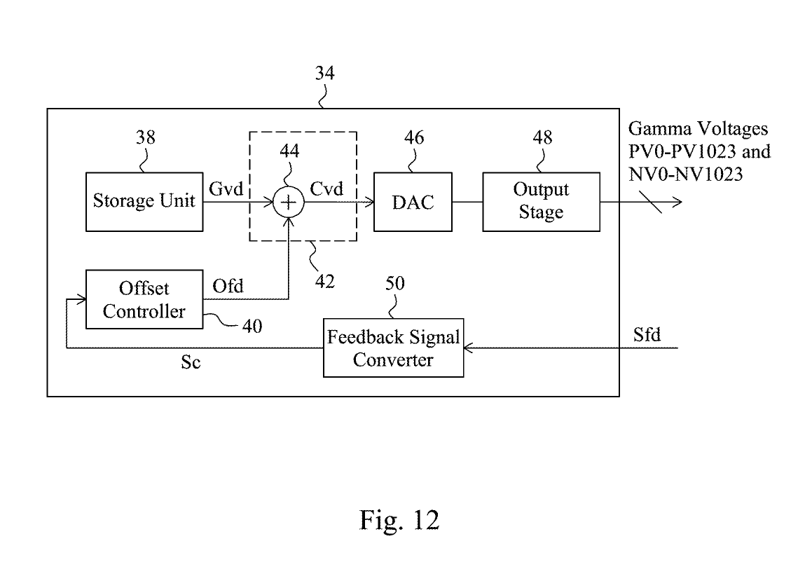

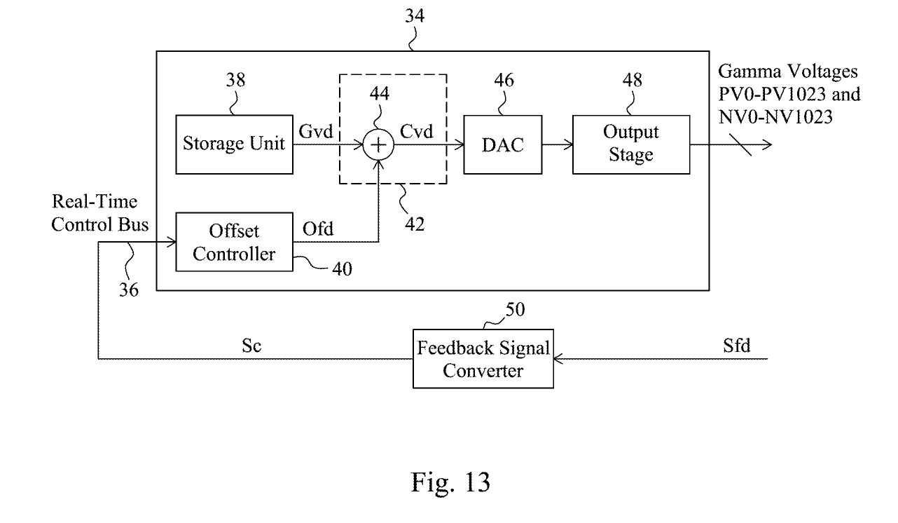

FIG. 12 shows a second embodiment of the Gamma voltage correction circuit 34 in FIG. 10. Like the embodiment in FIG. 11, the Gamma voltage correction circuit 34 in FIG. 12 includes the storage unit 38, the offset controller 40, the correction unit 42, the DAC 46, and the output stage 48. In addition, the Gamma voltage correction circuit 34 in FIG. 12 further includes a feedback signal converter 50. The feedback signal converter 50 is configured to receive and store a feedback signal Sfb, generate the correction signal Sc according to the feedback signal Sfb, and send the correction signal Sc to the offset controller 40. The feedback signal Sfb may be provided by the display panel 28. The feedback signal Sfb may be generated by detecting the brightness resulting from each of the Gamma voltages PV0-PV1023 and NV0-NV1023 and therefore can be used to correct the zero-flicker values Vzf0-Vzf1023 in real time by controlling the correction signal Sc in real time. FIG. 13 shows a different layout of the circuit in FIG. 12. In FIG. 13, the feedback signal converter 50 is arranged externally of the Gamma voltage correction circuit 34 and is configured to send the correction signal Sc to the Gamma voltage correction circuit 34 through the real-time control bus 36.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A Gamma curve correction method for a liquid crystal display having a plurality of positive Gamma voltages and a plurality of negative Gamma voltages to control grayscale levels of the liquid crystal display, the Gamma curve correction method comprising the steps of:
a.) setting a ground potential of the liquid crystal display as a common voltage; and
b.) adjusting at least one of the plurality of positive Gamma voltages and the plurality of negative Gamma voltages such that a central voltage value of a Gamma curve established by the plurality of positive Gamma voltages and the plurality of negative Gamma voltages becomes closer to the common voltage.

2. The Gamma curve correction method of claim 1, wherein the step b comprises the steps of:
setting an offset value; and
offsetting at least one of the plurality of positive Gamma voltages and the plurality of negative Gamma voltages according to the offset value.

3. The Gamma curve correction method of claim 1, wherein the step b comprises the steps of:
using an inter-integrated circuit to calculate offset values of the plurality of positive Gamma voltages and of the plurality of negative Gamma voltages respectively; and
adjusting the plurality of positive Gamma voltages and the plurality of negative Gamma voltages according to the offset values.

4. A liquid crystal display, comprising:
a display panel having a panel common electrode, wherein the panel common electrode is connected to a ground terminal, and a voltage at the panel common electrode serves as a common voltage of the display panel;
a Gamma voltage correction circuit for providing a plurality of pairs of Gamma voltages for controlling grayscale levels of the display panel and correcting the plurality of pairs of Gamma voltages according to a correction signal such that a zero-flicker value of each pair of Gamma voltages is equal to the common voltage, wherein the each pair of Gamma voltages include a positive Gamma voltage and a negative Gamma voltage that correspond to a same grayscale level, and the zero-flicker value of the each pair of Gamma voltages is a voltage value enabling the positive Gamma voltage and the negative Gamma voltage in the each pair of Gamma voltages to produce same brightness; and
a source driver connected to the display panel and the Gamma voltage correction circuit, wherein the source driver is configured for receiving the plurality of pairs of Gamma voltages and providing required Gamma voltages to the display panel.

5. The liquid crystal display of claim 4, wherein the Gamma voltage correction circuit comprises:
a storage unit for storing and outputting a plurality of voltage data;
an offset controller for determining a plurality of offset data according to the correction signal;
a correction unit connected to the storage unit and the offset controller, wherein the correction unit is configured for correcting the plurality of voltage data according to the plurality of offset data to generate a plurality of corrected voltage data;
a digital-to-analog converter (DAC) connected to the correction unit, wherein the DAC is configured for converting the plurality of corrected voltage data into the plurality of pairs of Gamma voltages; and
an output stage connected to the DAC, wherein the output stage is configured for storing the plurality of pairs of Gamma voltages and outputting the plurality of pairs of Gamma voltages to the source driver.

6. The liquid crystal display of claim 5, wherein the Gamma voltage correction circuit further comprises a feedback signal converter connected to the display panel and the offset controller, wherein the feedback signal converter is configured for generating the correction signal according to a feedback signal from the display panel and sending the correction signal to the offset controller.

7. The liquid crystal display of claim 4, further comprising a feedback signal converter connected to the display panel and the Gamma voltage correction circuit, wherein the feedback signal converter is configured for generating the correction signal according to a feedback signal from the display panel and sending the correction signal to the Gamma voltage correction circuit.

8. The liquid crystal display of claim 4, wherein the common voltage is not controlled or adjusted by an output of an operation amplifier which has an input receiving a feedback signal relating to the common voltage.

9. A Gamma curve correction method for a liquid crystal display, wherein the liquid crystal display has a plurality of pairs of Gamma voltages for controlling grayscale levels of a display panel of the liquid crystal display, the Gamma curve correction method comprising the steps of:
setting a ground potential of the liquid crystal display as a common voltage; and
adjusting the plurality of pairs of Gamma voltages according to a correction signal such that a zero-flicker value of each pair of Gamma voltages is equal to the common voltage, wherein the each pair of Gamma voltages include a positive Gamma voltage and a negative Gamma voltage that correspond to a same grayscale level, and the zero-flicker value of the each pair of Gamma voltages is a voltage value enabling the positive Gamma voltage and the negative Gamma voltage in the each pair of Gamma voltages to produce same brightness.

10. The Gamma curve correction method of claim 9, wherein the step of adjusting the plurality of pairs of Gamma voltages according to a correction signal comprises:
providing a plurality of voltage data;
determining a plurality of offset data according to the correction signal;
correcting the plurality of voltage data according to the plurality of offset data to generate a plurality of corrected voltage data; and
generating the plurality of pairs of Gamma voltages according to the plurality of corrected voltage data.

11. The Gamma curve correction method of claim 9, further comprising the step of generating the correction signal according to a feedback signal from the display panel.

12. The Gamma curve correction method of claim 9, wherein the common voltage is not controlled or adjusted by an output of an operation amplifier which has an input receiving a feedback signal relating to the common voltage.
